(19) United States
(12) Patent Application Publication
(10) Pub. No.: US 2018/0054048 A1
(43) Pub. Date: Feb. 22, 2018

(54) DEVICE FOR PROTECTING INSTALLED ELEMENTS DURING CONSTRUCTION

(71) Applicants: Darren Trimble, Snohomish, WA (US); Michael Nelson, Lynnwood, WA (US)

(72) Inventors: Darren Trimble, Snohomish, WA (US); Michael Nelson, Lynnwood, WA (US)

(21) Appl. No.: 15/243,444

(22) Filed: Aug. 22, 2016

(51) Int. Cl. H02G 3/08; H02G 3/14

(52) U.S. Cl. CPC H02G 3/081; H02G 3/14

(57) ABSTRACT

A device for the protection of wiring and cabling installed prior to the hanging of drywall or other construction or remodel efforts. The device is comprised essentially of at least one wall, a recess, and fastener holes that correspond to the fastener holes on standard old and new work boxes, ceiling boxes, or circuit breaker boxes. The recess and walls in concert form a solid perimeter of a volume, the solid perimeter preventing the intrusion of dust, paint, adhesives, drywall, and tools, as well as other common construction elements, into installed boxes. The solid protective device also prevents the inadvertent cutting or other damage to wiring and cables installed prior to the hanging and cutting of drywall. The device may include a door to allow access to elements while still providing protection from passive intrusion.

### BACKGROUND OF THE INVENTION

Wiring is necessarily installed in most new construction during the framing phase. New work boxes and electrical boxes are installed prior to the installation of drywall and mudding, and new and old work boxes may be exposed again during remodeling or reconditioning processes. It is critical to protect the installed wiring from intrusions, including but not limited to mud, paint, dust, sawdust, insects, moisture, and cutting tools. Moreover, drywall must necessarily be installed whole, leaving the builder to mark and then cut toward the box and the wiring contained therein. To date, no real solution exists for protecting the wiring installed prior to other construction phases. This is what the present invention aims to correct.

### SUMMARY OF THE INVENTION

This invention relates generally to construction, and, more specifically, to electrical boxes and the protection thereof.

Disclosed is a protective device configured to fit within standard single, double, triple, etc. old and new work gang boxes. The device is easily scaled to fit within circuit breaker boxes. The device is comprised essentially of at least one wall, a solid recess, and fastener holes that correspond to the fastener holes on standard old and new work boxes, ceiling boxes, or circuit breaker boxes. When in place, the device protects wiring from encroachment of paint, mud, dust, wallpaper adhesive, cutting tools such as rotozips and routers, and other elements common to construction or remodel sites. In preferred embodiments, the device is comprised of a material similar in properties as electrical gang boxes, which is to say that it is a strong, rigid plastic, capable of withstanding impacts from blunt objects and cutting tools without compromising the wiring within.

The foregoing is a summary and thus contains, by necessity, simplifications, generalizations and omissions of detail; consequently, those skilled in the art will appreciate that the summary is illustrative only and is NOT intended to be in any way limiting. Other aspects, embodiments, features and advantages of the device and/or processes and/or other subject matter described herein will become apparent in the teachings set forth herein.

### BRIEF DESCRIPTION OF THE DRAWINGS

Certain embodiments of the present invention are described in detail below with reference to the following drawings:

FIG. 1 is an isometric view of one embodiment of the box defender;

FIG. 2 is a front view of one embodiment of the box defender;

FIG. 3 is a side view of one embodiment of the box defender;

FIG. 4 is an isometric environmental view of one embodiment of the box defender in use;

FIG. 5 is a different isometric environmental view of one embodiment of the box defender in use; and

FIG. 6 is an isometric view of another embodiment of the box defender.

### DETAILED DESCRIPTION

This invention relates generally to construction, and, more specifically, to electrical boxes and the protection thereof.

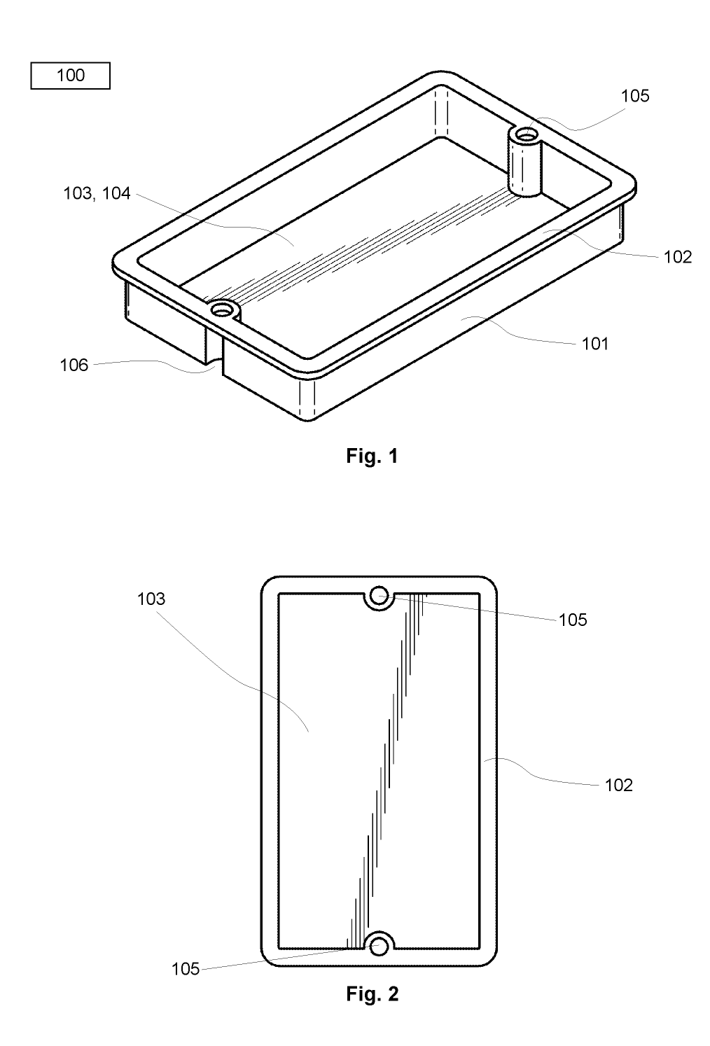

Specific details of certain embodiments of the invention are set forth in the following description and in FIGS. 1-5 to provide a thorough understanding of such embodiments. The present invention may have additional embodiments, may be practiced without one or more of the details described for any particular described embodiment, or may have any detail described for one particular embodiment practiced with any other detail described for another embodiment.

A primary goal of the box defender is to provide an impenetrable protective barrier for wall boxes, and thus the wiring within, installed prior to other construction or remodeling phases, such as hanging drywall. Currently, when drywall is hung over installed boxes, the installer must carefully measure where the box should end up relative to the drywall once it is installed, and then must basically make an educated guess as to where to begin the cut to allow access to the box. If the installer is incorrect in where to make the cut, the wiring within the box could be compromised, leading to significant, and costly, rework that may entail removing all of the wiring. When the box defender is in place, if the installer inadvertently cuts within the boundary of the box, the cutting implement merely nicks the box defender, preventing the unintentional destruction of the wiring. The same is true for circuit boxes, for which the box defender easily scales. In fact, currently, once circuit boxes are installed, many local codes require that no one other than the electrician opens them again. However, many drywall installers are forced to violate this code so that the drywall can be hung properly. With the box defender, the electrician can place the defender in the circuit box, the drywall can be hung and cut, and then the box can be closed.

FIG. 1 is an isometric view of the box defender 100. The box defender 100 is comprised essentially of walls 101 that form a solid perimeter, a rim 102 that allows the box defender to sit against the rim of wall boxes, a recessed area 104 with solid floor 103, fastener holes 105, and fastener berth 106. Walls 101 are configured to easily slide just inside the perimeter of boxes, creating a snug fit, but not one that relies on strong pressure to remove the defender 100. Walls 101 are short in depth relative to the depth of wall boxes, which allows plenty of room for the wires or cables within the box. At the top and bottom of the box defender 100, walls 101 may include fastener berths 106, which are recesses in the wall configured to slip over the fastener holes at the top and bottom of standard wall boxes. This makes the box defender 100 almost universally compatible with both old and new work boxes.

Since the perimeter of defender 100 is necessarily slightly smaller than the perimeter of wall boxes, the box defender includes a rim 102. Rim 102 is configured to sit atop the gap between the inside wall of the box and the outside wall of the box defender, preventing the intrusion of undesirable elements into the box through said gap. In preferred embodiments, rim 102 includes fastener holes 105. Fastener holes 105 are designed to correspond with the fastener holes in wall boxes, such that both the box and the box defender 100 are able to be fastened into place during further construction. Fastener holes 105 also correspond to fastener berth 106, allowing for a near-perfect fit within the perimeter of the wall boxes. Fasteners may not be required for some applications, and, as such, some embodiments of the box defender may not include fastener holes 105 or berths 106.

Box defender 100 also critically includes recess 104. In preferred embodiments, recess 104 includes a solid floor 103, the solid floor being solidly joined with walls 101 around the entire perimeter. Recess 104 generally corresponds to the depth of walls 101, though it will be slightly shallower due to the thickness of the material. When in place, walls 101 and floor 103 create an impregnable cover for wall boxes, leaving only the fastener holes 105 exposed. When fasteners are in place, the entire box, and the wiring or cables within, are protected.

FIG. 2 is a front view of the box defender, showing that rim 102 includes fastener holes 105 at the top and bottom. If the box is installed sideways, then the box defender 100 is easily rotated to correspond to the orientation of the box.

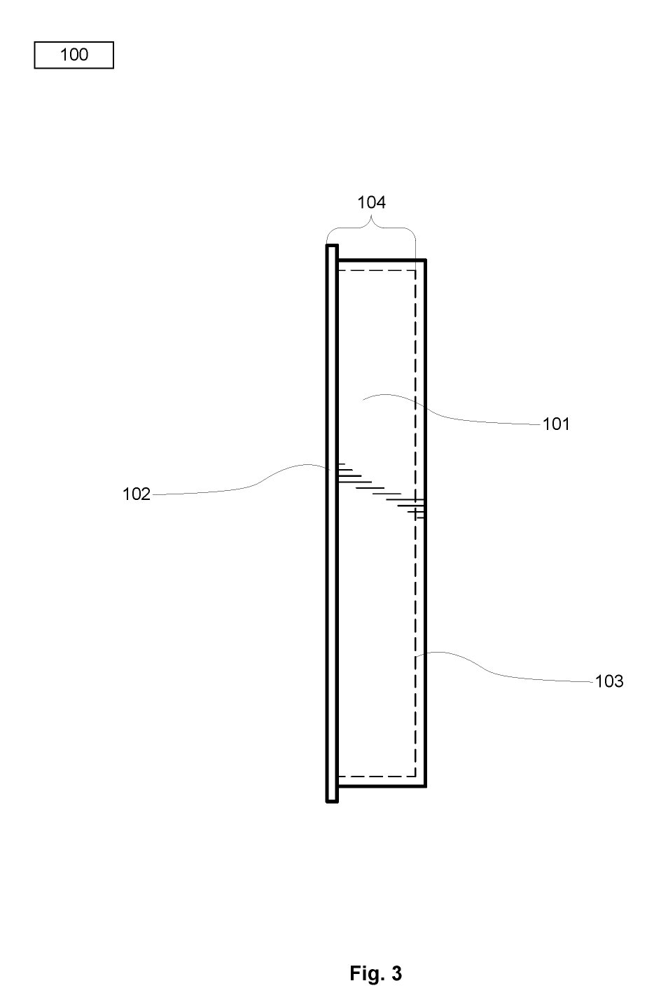

FIG. 3 is a side view showing the depth of box defender 100. Particularly, it can be seen that recess 104, formed by rim 102 and floor 103, is approximately as deep as wall 101. Or, alternatively, that wall 101 corresponds in depth directly to the depth of recess 104. This recess allows for lighter box defenders 100, as well as preventing the recess from adhering to or interfering with walling installation.

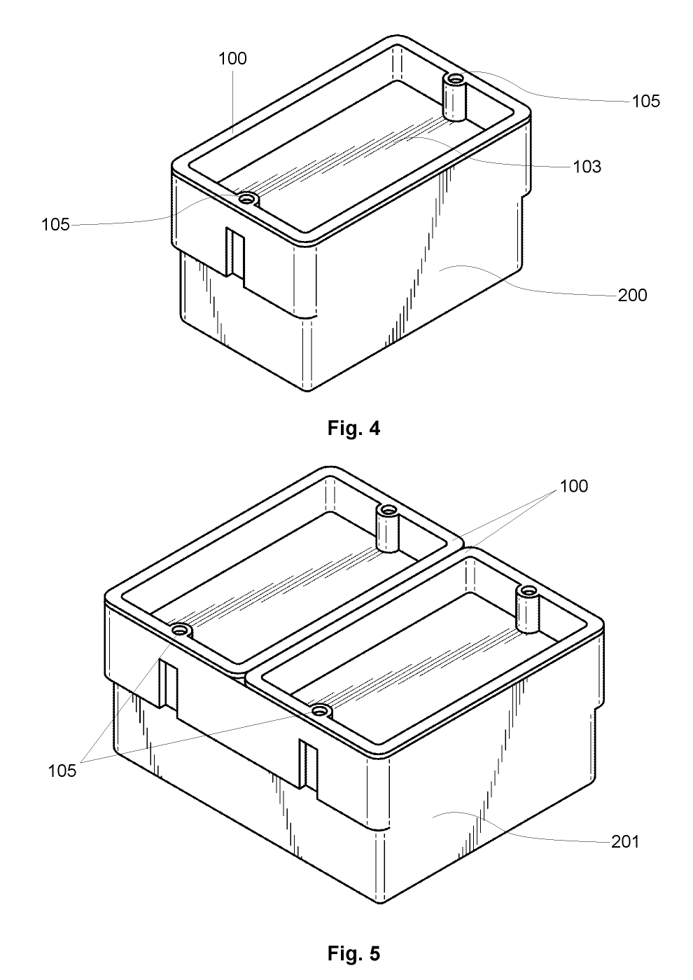

FIG. 4 is an environmental view of the box defender 100 in place in a single gang wall box 200. It can be seen that holes 105 directly correspond to the fastener holes in the wall box, and that floor 103 forms a solid protective layer over the entire volume of the box 200.

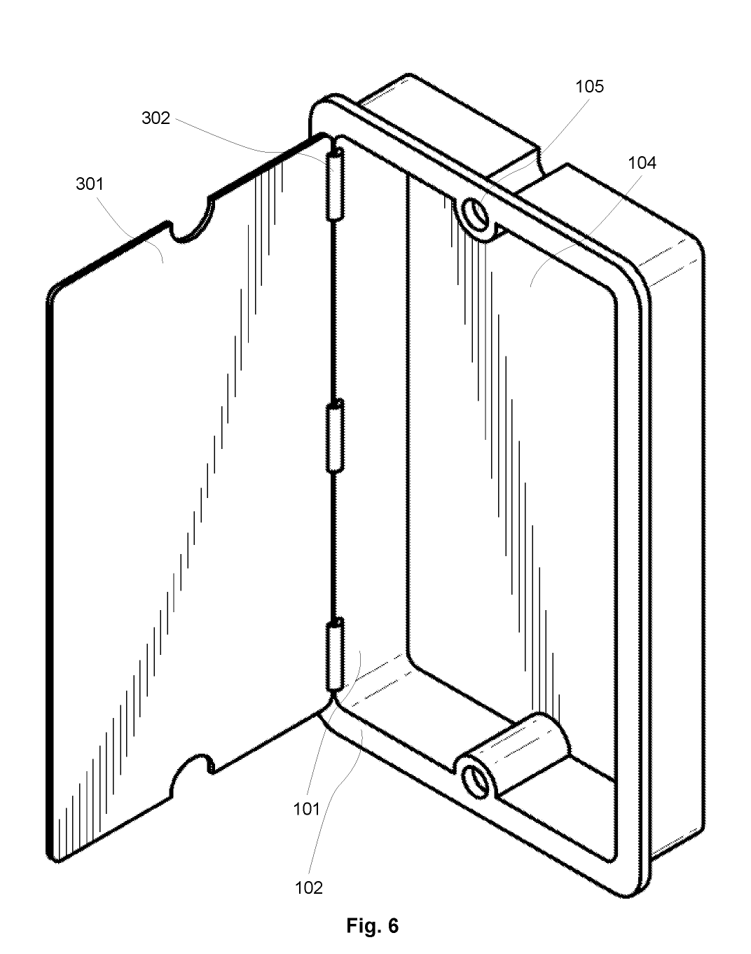

FIG. 5 is an environmental view of the box defender 100 in place in a double gang box 201. In some embodiments, the box defender 100 may simply be multiplied to correspond to double, triple, quadruple, etc. gang wall boxes. In this application, each single gang box defender 100 is placed in a position such that fastener holes 105 correspond to the fastener holes of the multiple gang box, as seen in FIG. 5. In other embodiments, the box defender 100 may be scaled to meet the size of the box without multiplying the number of single gang defenders. This is particularly applicable for circuit boxes.

FIG. 6 is an isometric view of a different embodiment of the box defender 100, in which the box defender includes at least one door 301. This embodiment, while applicable as above, may also be applicable for circuit boxes such as, in one non-limiting example, a 200 amp electrical panel. For this use, the box defender 100 would be sized appropriately, and the locations of holes 105 may shift to align with the fasteners for the electrical panel. Door 301 may be permanently or removably coupled with box defender 100 via one or more hinges 302. In some embodiments, hinge 302 may be a standard butt or Mortise style hinge. In other embodiments, hinge 302 may be a spring loaded or gate hinge, inducing door 301 to close upon release to offer an additional element of protection. Hinge 302 may, in some embodiments, be a simple joint of a more flexible material that allows the door to open and close, without actually including a pin or plate like other hinges. In a further embodiment, door 301, hinge 302, and box defender 100 may be a single unit machined or extruded such that the door is flexibly affixed to the box defender by the hinge, while permitting a user or installer to carry a single unit rather than multiple elements of the combination. Hinge 302 may join door 301 to box defender 100 at wall 101 or rim 102. While FIG. 6 depicts door 301 opening horizontally and joined with the left side of box defender 100, it should be understood that hinge 302 may join the door to the box defender on either lateral side or on the top or bottom of the box defender. In some embodiments, recess 104 may include floor 103, but in other embodiments, floor 103 may be removed to allow access to the electrical elements once the door 301 is open.

While the actual material of the box defender 100 is not disclosed, particular material properties should be considered. First, the material should be lightweight, such that carrying multiple box defenders around a construction site is not unduly burdensome. Second, the material should be substantially rigid, holding its shape whether or not it is in place in a wall box. Third, the material should be durable. One primary goal of the box defender is to prevent cutting tools from nicking or cutting wires and cables within the box, and a material that easily yields to cutting tools is improper. Finally, the material should be chemically non-reactive and non-conductive. Construction sites are full of corrosive materials, adhesives, paints, etc., and a chemically non-reactive material would be strongly preferred. A non-conductive material is particularly desired, as well, given that a primary purpose of the defender is to protect electrical wiring from the intrusion of other construction materials. For these reasons, a particularly ideal material is a non-conductive rigid PVC. However, it should be understood that other materials, such as wood, might also be sufficient.

It also should be understood that each of the elements disclosed herein could be a single element, all of which are brought together to form the single box defender. For instance, floor 103 might be welded to walls 101, forming an impregnable barrier. However, it should also be understood that other manufacturing methods, such as extruding or molding a plastic, or machining of plastics or other materials, such that the entire defender is essentially a single piece of material, would be sufficient.

Finally, it should also be understood that, while the box defender disclosed herein is configured for rectangular boxes, the same essential elements (walls, floors, rims) could be combined to form different perimeters. For example, ceiling boxes are typically round, but are no less vulnerable during later construction phases, and the box defender could easily be reconfigured to correspond directly to a ceiling box, offering the same benefits as it does with the wall boxes.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

While preferred and alternative embodiments of the invention have been illustrated and described, as noted above, many changes can be made without departing from the spirit and scope of the invention. Accordingly, the scope of the invention is not limited by the disclosure of these preferred and alternate embodiments.

What is claimed is:

1. A construction device, comprising:
a rigid wall forming an inside perimeter and an outside perimeter;
a rim coupled with the rigid wall such that it overhangs the outside perimeter; and
a floor coupled with the inside perimeter.

2. The device of claim 1, wherein the rigid wall forming an inside perimeter and an outside perimeter is essentially rectangular, with a top end and a bottom end.

3. The device of claim 2, wherein at least one of the top end or the bottom end of the rigid wall includes at least one fastener berth.

4. The device of claim 3, wherein the rim coupled with the rigid wall includes at least one fastener hole corresponding to the at least one fastener berth.

5. The device of claim 1, wherein the rigid wall forming an inside perimeter and an outside perimeter is essentially circular.

6. The device of claim 5, wherein the rigid wall includes at least one fastener berth.

7. The device of claim 6, wherein the rim coupled with the rigid wall includes at least one fastener hole corresponding to the at least one fastener berth.

8. The construction device of claim 1, further comprising:
at least one door, the at least one door coupled with at least one side of the rigid wall.

9. The construction device of claim 1, wherein the floor coupled with the inside perimeter is solid such that the entire device is essentially impregnable.

10. A construction device, comprising:
at least one essentially rectangular rigid wall forming an inside perimeter and an outside perimeter, the rigid wall including at least:
a top end, the top end including at least one fastener berth; and
a bottom end, the bottom end including at least one fastener berth;
at least one rim coupled with the rigid wall, the at least one rim configured to overhang the outside perimeter of the at least one rigid wall and including at least:
at least one fastener hole corresponding to the at least one top end fastener berth; and
at least one fastener hole corresponding to the at least one bottom end fastener berth; and
at least one floor, the at least one floor coupled with the inside perimeter formed by the at least one rigid wall such that a volume formed by the wall and the floor is essentially impregnable.

11. A construction device, comprising:
at least one essentially circular rigid wall forming an inside perimeter and an outside perimeter, the rigid wall including at least one fastener berth;
at least one rim coupled with the rigid wall, the at least one rim configured to overhang the outside perimeter of the at least one rigid wall and including at least one fastener hole corresponding to the at least one fastener berth; and
at least one floor, the at least one floor coupled with the inside perimeter formed by the at least one rigid wall such that a volume formed by the wall and the floor is essentially impregnable.
